(19) United States
(12) Patent Application Publication
(10) Pub. No.: US 2022/0338447 A1
(43) Pub. Date: Oct. 27, 2022

(54) DEFECATION PANTY FOR PETS

(71) Applicant: Kun PARK, Gwangmyeong-si, Gyeonggi-do (KR)

(72) Inventor: Kun PARK, Gwangmyeong-si, Gyeonggi-do (KR)

(21) Appl. No.: 17/760,867

(22) PCT Filed: Jul. 30, 2020
(86) PCT No.: PCT/KR2020/010068

§ 371 Date: Mar. 16, 2022

(30) Foreign Application Priority Data
Oct. 25, 2019 (KR) 10-2019-0134080

(51) Int. Cl. A01K 23/00

(52) U.S. Cl. CPC A01K 23/00

(57) ABSTRACT

An object of the present invention is to provide a defecation panty for pets capable of easily collecting feces of pet dogs and the like outdoors or indoors, wherein the defecation panty for pets of the present invention is used for pets excreting feces with the buttock lowered and includes a bag mounting part detachably provided with a bag and having a guide hole for feces; and a buttock wearing part for wearing the bag mounting part on the buttock.

### TECHNICAL FIELD

The present invention relates to a defecation panty for pets.

### BACKGROUND ART

In general, pets are animals that humans mainly breed for having the pleasure, and representatively, include pet dogs, pet cats, and the like. Today, the expression “companion animal” is becoming more and more popular in the sense of treating the pets as companions (friends) rather than possessions for human pleasure.

In Korea, the number of people living with pets is already over 10 million. As the number of single-person families increases and the elderly population increases, the number of pets is expected to increase even more.

In particular, among the pets, pet dogs, pet cats, and the like take a walk with their owners to consume energy or develop social skills.

However, in order to collect the feces of pet dogs and the like excreted during walks, the their owners have an inconvenient problem to take plastic bags, toilet paper, wet tissues, and the like, and have an inconvenient problem to collect the feces excreted by the pet dogs with tongs or tissues and put the collected feces in a plastic bag, etc.

### DISCLOSURE

### Technical Problem

An object of the present invention is to provide a defecation panty for pets capable of easily collecting the feces excreted by pet dogs and the like outdoors or indoors.

### Technical Solution

According to an aspect of the present invention, a defecation panty for pets of the present invention is used for pets excreting the feces with the buttock lowered and includes a bag mounting part detachably provided with a bag and having a guide hole for feces; and a buttock wearing part for wearing the bag mounting part on the buttock.

The bag mounting part may include a bag mounting body having the guide hole for feces; a protruding member which is provided to protrude from the bag mounting body and has a hollow cylindrical shape communicating with the guide hole for feces; and a socket member which is fastened to the protruding member so that an opening part of the bag is fixed between the socket member and the protruding member.

The bag mounting part may further include a cover which is provided rotatably up and down on the upper portion of the socket member, usually covers the bag together with the socket member, and is opened when the pet lowers the buttock for defecation.

The buttock wearing part may include a buttock wearing body provided in the bag mounting body and having a hollow part communicating with the guide hole for feces; a tail hanger provided on the upper portion of the buttock wearing body and hung on the pet's tail; and a wearing band part provided around the buttock wearing body and covering the buttocks and hind legs of the pet.

The defecation panty for pets according to the exemplary embodiment of the present invention described above may further include an intermediate detaching part provided so as to detachably attach the bag mounting part to the buttock wearing part.

The intermediate detaching part may include a magnet provided in any one of the bag mounting body and the buttock wearing body; and a magnet reaction member provided in the other one of the bag mounting body and the buttock wearing body and attached in response to the magnet.

The bag mounting part may further include a screw fastening part which screw-fastens the protruding member and the socket member to each other with the bag interposed therebetween, and the screw fastening part may include a male screw thread formed on an outer circumferential surface of the protruding member; and a female screw thread formed on an inner circumferential surface of the socket member so as to be screw-fastened to the male screw thread.

The wearing band part may include a plurality of band hangers provided around the buttock wearing body at intervals along the circumference of the buttock wearing body; and one or more wearing bands covering the buttocks and hind legs while being caught on each band hanger.

The tail hanger may have a ring shape surrounding the tail and be made of an elastic material and the each wearing band may be made of an elastic material to conform to the movement of the pet.

The bag may include a fastening strap which is provided in an opening part thereof and tightens the opening part.

The bag may be a plastic bag.

### Advantageous Effects

As described above, the defecation panty for pets according to the exemplary embodiment of the present invention may have the following effects.

According to the exemplary embodiment of the present invention, there is provided a technical configuration including a bag mounting part and a buttock wearing part as a defecation panty for pets used for pets excreting the feces with the buttock lowered. Accordingly, it is possible to mount the bag by the bag mounting part and mount the bag mounting part mounted with the bag on the buttock of the pet by the buttock wearing part so that the guide hole for feces of the bag mounting part corresponds to the anus of the pet. Therefore, when the pet such as a pet dog excretes the feces outdoors or indoors, the excreted feces falls down into the bag without falling down on the ground to be easily collected, thereby ultimately allowing a user to hygienically dispose of the feces without ambient odor or contamination of the ground by detaching and removing only the bag by the bag mounting part.

Further, according to the exemplary embodiment of the present invention, there is provided a technical configuration in which the bag mounting part includes a bag mounting body, a protruding member, and a socket member. Accordingly, it is possible to easily mount an opening part of the bag between an outer surface of the protruding member and an inner surface of the socket member while the socket member is fitted to the protruding member.

Further, according to the exemplary embodiment of the present invention, there is provided a technical configuration in which a cover is provided rotatably up and down on the upper portion of the socket member. Accordingly, it is possible to store the bag in the inner space of the socket member when the cover is placed in a closed state while the load of the cover is applied to the cover in a direction in which the cover is closed in normal times such as walking. In addition, when the cover is placed in an open state while the load of the cover is applied to the cover in the direction in which the cover is opened when a pet such as a pet dog lowers the buttock for defecation, the bag is removed out of the socket member and simultaneously, the inner space of the bag may be secured, so that the excreted feces may be collected in the secured inner space of the bag.

Further, according to the exemplary embodiment of the present invention, there is provided a technical configuration in which the buttock wearing part includes a buttock wearing body, a tail hanger, and a wearing band part. Accordingly, the bag mounting body may be provided on the buttock wearing body, the tail hanger may be hung on the pet's tail, and the wearing band may cover the buttocks and hind legs of the pet, so that the bag mounting part may be kept to be worn on the buttock through the buttock wearing part even if the pet, such as a pet dog, performs a rough activity such as running.

Further, according to the exemplary embodiment of the present invention, there is provided a technical configuration including an intermediate detaching part provided so as to detachably attach the bag mounting part to the buttock wearing part. Accordingly, without forcefully detaching the bag in which the feces are collected while the buttock wearing part is mounted on the buttock, the bag mounted on the bag mounting part may be detached while the bag mounting part is detached from the buttock wearing part to be replaced with a new bag without causing inconvenience to the pet such as a pet dog.

Further, according to the exemplary embodiment of the present invention, there is provided a technical configuration in which the intermediate detaching part includes a magnet and a magnet reaction member. Accordingly, it is possible to quickly attach and detach any one of the bag mounting body and the buttock wearing body provided with the magnet to and from the other one provided with the magnet reaction member through magnetic force.

Further, according to the exemplary embodiment of the present invention, there is provided a technical configuration of including a male screw thread formed on an outer circumferential surface of the protruding member, and a female screw thread formed on an inner circumferential surface of the socket member so as to be screw-fastened to the male screw thread. Accordingly, the protruding member and the socket member may be fastened to each other with the bag interposed therebetween, that is, the opening part of the bag may be fixed through the male screw thread and the female screw thread with sufficient frictional force between the protruding member and the socket member, thereby preventing the bag from being removed while the excreted feces are collected.

Further, according to the exemplary embodiment of the present invention, there is provided a technical configuration in which the tail hanger and the wearing band are made of elastic materials. Accordingly, it is possible to keep the defecation panty for pets to be fixed to the buttock even while minimizing interference with the movement of pets such as pet dogs.

Further, according to the exemplary embodiment of the present invention, since there is provided a technical configuration in which the tightening strap is provided on the opening part of the bag, the opening part of the bag may be closed when the tightening strap is pulled after the bag is detached. Accordingly, the user can dispose of the feces hygienically while minimizing the user's hand from being in contact with the opening part of the bag.

### DESCRIPTION OF DRAWINGS

FIG. 1 is a diagram schematically illustrating a defecation panty for pets according to an exemplary embodiment of the present invention.

FIG. 2 is a diagram schematically illustrating a side surface of the defecation panty for pets of FIG. 1.

FIG. 3 is an enlarged view illustrating the defecation panty for pets of FIG. 1. FIG. 4 is a diagram schematically illustrating a process of mounting a bag on a bag mounting part of the defecation panty for pets of FIG. 1.

FIG. 5 is a diagram schematically illustrating a state where the bag mounted on the bag mounting part of FIG. 4 is closed inside the bag mounting part by a cover.

FIG. 6 is a diagram schematically illustrating a state where the cover of the bag mounting part is opened in the defecation panty for pets of FIG. 2.

FIG. 7 is a diagram schematically illustrating a state of wearing the defecation panty for pets of FIG. 1 on a pet dog.

FIG. 8 is a diagram schematically illustrating a motion in which a pet dog excretes feces with the buttock lowered.

FIG. 9 is a diagram schematically illustrating a state where the bag mounting part is separated from the buttock wearing part through an intermediate detaching part in the defecation panty for pets of FIG. 9.

FIG. 10 is a diagram schematically illustrating a state where an opening part is tightened through a tightening strap while the bag of FIG. 9 is detached from the bag mounting part.

FIG. 11 is a diagram schematically illustrating various modifications of the defecation panty for pets according to an exemplary embodiment of the present invention.

### MODES FOR THE INVENTION

Hereinafter, exemplary embodiments of the present invention will be described in detail with reference to the accompanying drawings so as to easily implement those with ordinary skill in the art to which the present invention pertains. However, the present invention may be implemented in various different forms and is not limited to the exemplary embodiments described herein.

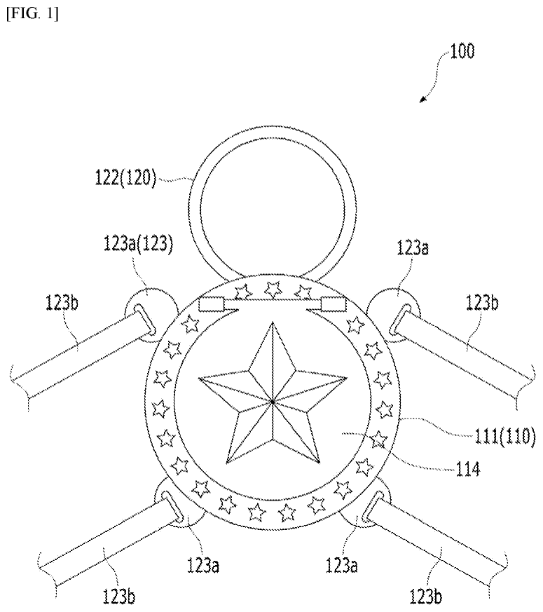

FIG. 1 is a diagram schematically illustrating a defecation panty for pets according to an exemplary embodiment of the present invention,

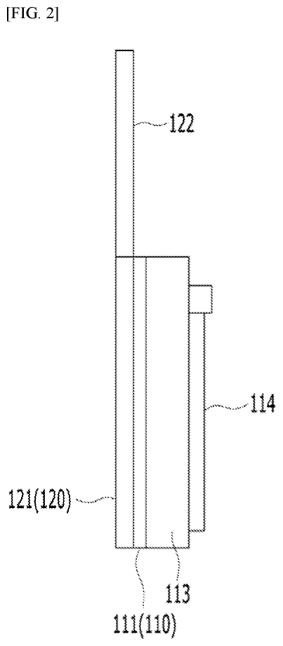

FIG. 2 is a diagram schematically illustrating a side surface of the defecation panty for pets of FIG. 1, and

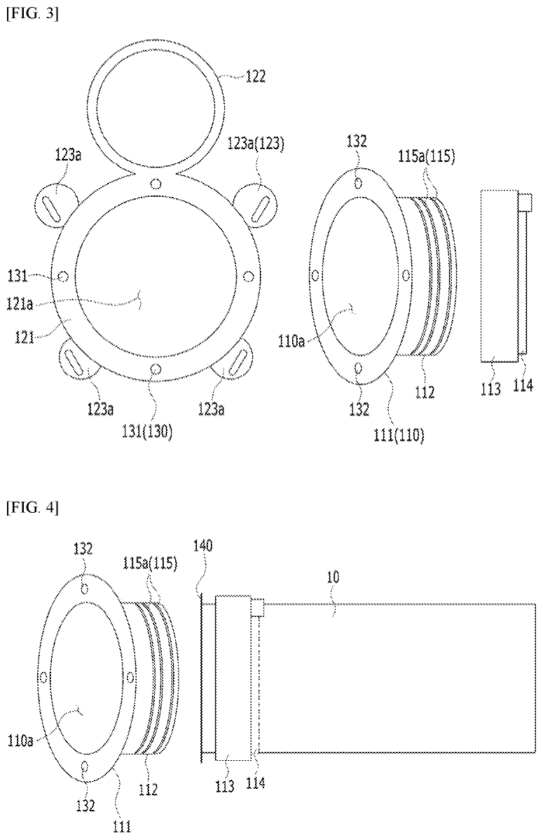

FIG. 3 is an enlarged view illustrating the defecation panty for pets of FIG. 1.

FIG. 4 is a diagram schematically illustrating a process of mounting a bag on a bag mounting part of the defecation panty for pets of FIG. 1,

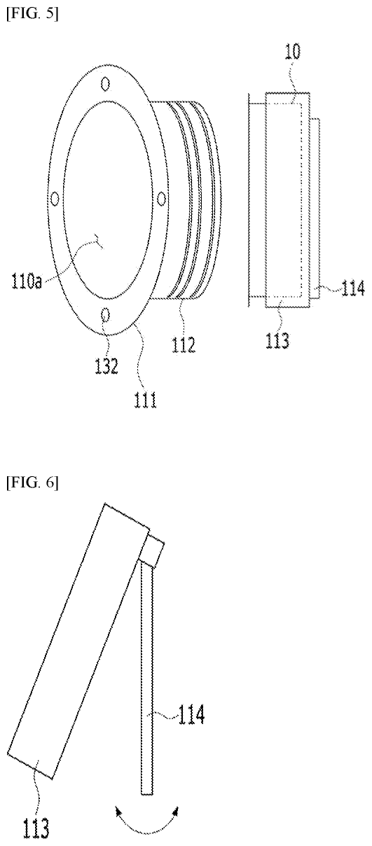

FIG. 5 is a diagram schematically illustrating a state where the bag mounted on the bag mounting part of FIG. 4 is closed inside the bag mounting part by a cover, and

FIG. 6 is a diagram schematically illustrating a state where the cover of the bag mounting part is opened in the defecation panty for pets of FIG. 2.

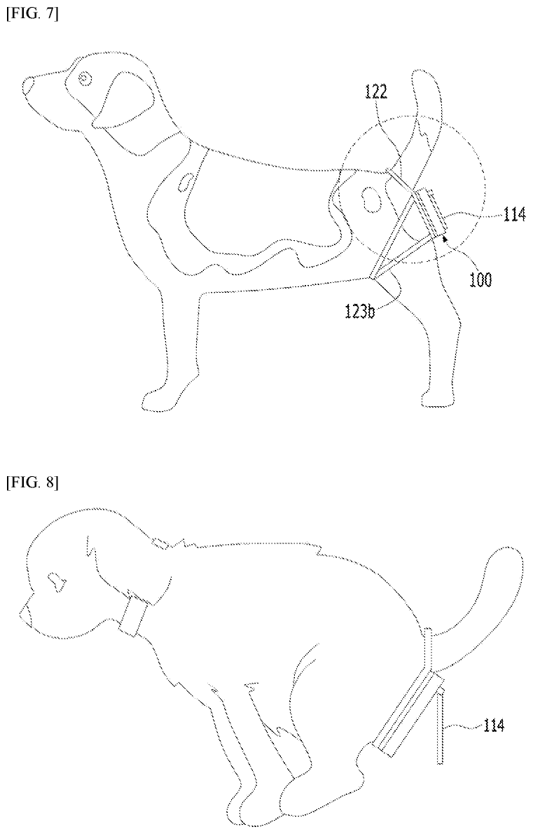

FIG. 7 is a diagram schematically illustrating a state of wearing the defecation panty for pets of FIG. 1 on a pet dog and

FIG. 8 is a diagram schematically illustrating a motion in which a pet dog excretes feces with the buttock lowered.

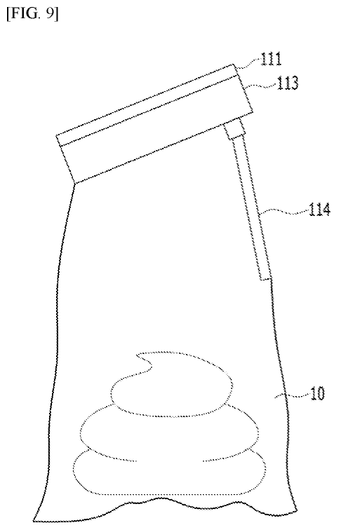

FIG. 9 is a diagram schematically illustrating a state where the bag mounting part is separated from the buttock wearing part through an intermediate detaching part in the defecation panty for pets of FIG. 9 and

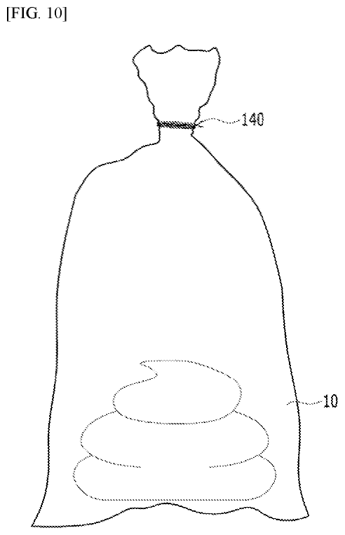

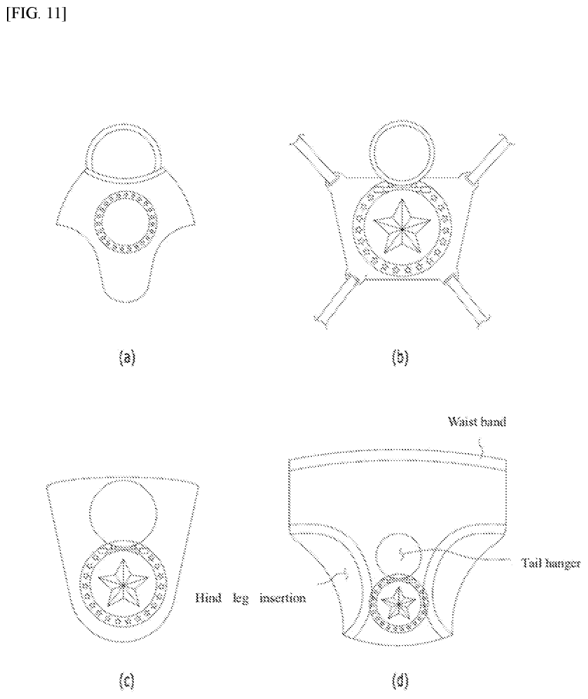

FIG. 10 is a diagram schematically illustrating a state where an opening part is tightened through a tightening strap while the bag of FIG. 9 is detached from the bag mounting part.

FIG. 11 is a diagram schematically illustrating various modifications of the defecation panty for pets according to an exemplary embodiment of the present invention.

A defecation panty 100 for pets according to an exemplary embodiment of the present invention, as illustrated in FIGS. 1 to 10, is used for pets excreting the feces with the buttock lowered and includes a bag mounting part 110 and a buttock wearing part 120. Hereinafter, respective components will be described in detail with reference to FIGS. 1 to 10.

The bag mounting part 110 is a component for detachably providing a bag 10. As illustrated in FIGS. 3 to 5, the bag mounting part 110 may have a guide hole 110a for feces to guide the feces excreted by a pet such as a pet dog into the bag 10 mounted thereon.

The buttock wearing part 120 is a component for wearing the bag mounting part 110 on the buttock of a pet such as a pet dog. The buttock wearing part 120 may position the guide hole 110a for feces of the bag mounting part 110 to correspond to the anus of the pet such as a pet dog, and keep the position to be substantially fixed thereto.

Accordingly, since these components are provided, the bag 10 may be mounted by the bag mounting part 110 and the bag mounting part 110 mounted with the bag 10 may be mounted on the buttock of the pet by the buttock wearing part 120 so that the guide hole 110a for feces of the bag mounting part 110 corresponds to the anus of the pet. Therefore, as illustrated in FIGS. 8 and 9, when the pet such as a pet dog excretes the feces outdoors or indoors, the excreted feces falls down into the bag 10 without falling down on the ground to be easily collected, thereby ultimately allowing a user to hygienically dispose of the feces without ambient odor or contamination of the ground by detaching and removing only the bag 10 by the bag mounting part 110.

Hereinafter, the bag mounting part 110 and the buttock wearing part 120 will be described in more detail with reference to FIGS. 1 to 10.

As illustrated in FIGS. 3 to 5, the bag mounting part 110 may include a bag mounting body 111, a protruding member 112, and a socket member 113. The bag mounting body 111 may have a plate shape and the guide hole 110a for feces in the center thereof. The protruding member 112 may be provided to protrude from the bag mounting body 111 and may have a hollow cylindrical shape communicating with the guide hole 110a for feces, and the socket member 113 may be inserted and fastened to the protruding member 112 so that an opening part of the bag 10 is fixed between the socket member 113 and the protruding member 112.

Accordingly, while the socket member 113 is fitted to the protruding member 112, the opening part of the bag 10 may be mounted simply and easily between the outer surface of the protruding member 112 and the inner surface of the socket member 113.

Further, the bag mounting part 110 may further include a cover 114 as illustrated in FIGS. 1 and 9. The cover 114 may be provided rotatably up and down on the upper portion of the socket member 113, may usually cover the bag 10 together with the socket member 113, and may be opened when the pet lowers the buttock for defecation.

Therefore, when the cover 114 is placed in a closed state while the load of the cover 114 is applied to the cover 114 in a direction in which the cover 114 is closed in normal times such as walking, the bag 10 may be stored in the inner space of the socket member 113. In addition, when the cover 114 is placed in an open state while the load of the cover 114 is applied to the cover 114 in the direction in which the cover 114 is opened when a pet such as a pet dog lowers the buttock for defecation, the bag 10 is removed out of the socket member 113 and simultaneously, the inner space of the bag 10 may be secured, so that the excreted feces may be collected in the secured inner space of the bag 10.

Further, the bag mounting part 110 may further include a screw fastening part 115 as illustrated in FIGS. 3 and 5. The screw fastening part 115 may screw-fasten the protruding member 112 and the socket member 113 to each other with the bag 10 interposed therebetween. For example, the screw fastening part 115, as illustrated in FIGS. 3 to 5, may include a male screw thread 115a formed on an outer circumferential surface of the protruding member 112, and a female screw thread (not illustrated) formed on an inner circumferential surface of the socket member 113 so as to be screw-fastened to the male screw thread 115a.

Accordingly, the screw fastening part 115 may screw-fasten the protruding member 112 and the socket member 113 to each other with the bag 10 interposed therebetween, that is, the opening part of the bag 10 may be fixed through the male screw thread 115a and the female screw thread (not illustrated) with sufficient frictional force between the protruding member 112 and the socket member 113, thereby preventing the bag from being removed while the excreted feces are collected.

Meanwhile, as illustrated in FIGS. 1 to 3 and 7, the buttock wearing part 120 may include a buttock wearing body 121, a tail hanger 122, and a wearing band part 123. The buttock wearing body 121 may have a plate shape, may be provided in the bag mounting body 111, and may have a hollow part 121a communicating with the guide hole 110a for feces. The tail hanger 122 may be provided on the upper portion of the buttock wearing body 121 and may be hung on the pet's tail, and the wearing band part 123 may be provided around the buttock wearing body 121 and may cover the buttocks and hind legs of the pet. Furthermore, although not illustrated, the buttock wearing body 121 may also be provided integrally (into one body) with the bag mounting body 111, and may be detachably provided through the intermediate detaching part 130 as be described below.

Therefore, the bag mounting body 111 may be provided on the buttock wearing body 121, the tail hanger 122 may be hung on the pet's tail, and the wearing band part 123 may cover the buttocks and hind legs of the pet, so that the bag mounting part 110 may be kept to be worn on the buttock through the buttock wearing part 120 even if the pet, such as a pet dog, performs a rough activity such as running.

Furthermore, the wearing band part 123 may include a plurality of band hangers 123a and one or more wearing bands 123b, as illustrated in FIGS. 1, 3 and 7. The plurality of band hangers 123a may be provided around the buttock wearing body 121 at intervals along the circumference of the buttock wearing body 121, and the wearing band 123b may cover the buttocks and hind legs while being caught on the band hanger 123a.

In addition, the tail hanger 122 may have a ring shape surrounding the tail and may be made of an elastic material such as silicone or rubber band, and each wearing band 123b may also be made of an elastic material such as silicone or rubber band to conform to the movement of the pet.

In addition, the defecation panty 100 for pets according to an embodiment of the present invention may further include an intermediate detaching part 130 as illustrated in FIG. 3. The intermediate detaching part 130 may be provided so as to detachably attach the bag mounting part 110 to the buttock wearing part 120.

Accordingly, without forcefully detaching the bag 10 in which the feces are collected while the buttock wearing part 120 is mounted on the buttock, the bag 10 mounted on the bag mounting part 110 may be detached while the bag mounting part 110 is detached from the buttock wearing part 120 to be replaced with a new bag without causing inconvenience to the pet such as a pet dog.

For example, the intermediate detaching part 130, as illustrated in FIG. 3, may include a magnet 131 provided in the buttock wearing body 121 and a magnet reaction member 132 provided in the bag mounting body 111 and attached by magnetic force in response to the magnet 131. Here, the magnet reaction member 132 may be a metal attached to the magnet 131 or another magnet having an opposite polarity to the magnet 131. Of course, as another example, although not illustrated, the magnet may be provided on the buttock wearing body and the magnet reaction member may also be provided on the bag mounting body.

Therefore, the intermediate detaching part 130 may be quickly attached and detached through the magnetic force of the magnet 131.

On the other hand, the bag 10 may include a tightening strap 140 which is provided in the opening part thereof and tightens the opening part. Accordingly, when the tightening strap 140 is pulled after the bag 10 is detached, the opening part of the bag 10 may be closed, so that the user may dispose of the feces hygienically while minimizing the user's hand from being in contact with the opening part of the bag.

In addition, the bag 10 may be a waterproof plastic bag. On the other hand, FIGS. 11A, 11B, 11C, and 11D are diagrams schematically illustrating various modifications of the defecation panty for pets according to an exemplary embodiment of the present invention.

While the preferred exemplary embodiment of the present invention has been described in detail, the scope of the present invention is not limited thereto, and various modifications and improvements of those skilled in the art using a basic concept of the present invention defined in the appended claims also belong to the scope of the present invention.

### INDUSTRIAL APPLICABILITY

The present invention relates to a defecation panty for pets and has industrial applicability.

1. A defecation panty for pets used for pets excreting the feces with the buttock lowered, comprising:
a bag mounting part detachably provided with a bag and having a guide hole for feces; and
a buttock wearing part configured to wear the bag mounting part on the buttock.

2. The defecation panty for pets of claim 1, wherein the bag mounting part comprises
a bag mounting body having the guide hole for feces;
a protruding member which is provided to protrude from the bag mounting body and has a hollow cylindrical shape communicating with the guide hole for feces; and
a socket member which is fastened to the protruding member so that an opening part of the bag is fixed between the socket member and the protruding member.

3. The defecation panty for pets of claim 2, wherein the bag mounting part further comprises a cover which is provided rotatably up and down on the upper portion of the socket member, usually covers the bag together with the socket member, and is opened when the pet lowers the buttock for defecation.
